(19) United States
(12) Patent Application Publication
(10) Pub. No.: US 2019/0331011 A1
(43) Pub. Date: Oct. 31, 2019

(54) EXHAUST-GAS EMISSION CONTROL SYSTEM COMPRISING A FILTER FUNCTION AND DIAGNOSTIC METHOD FOR SAID SYSTEM

(71) Applicant: IAV GMBH INGENIEURGESELLSCHAFT AUTO UND VERKEHR, Berlin (DE)

(72) Inventors: Lutz KRAEMER, Falkensee (DE); Florian BROEER, Braunschweig (DE); Paul TOURLONIAS, Berlin (DE); Sascha SENGPIEHL, Berlin (DE); Karsten KLUG, Berlin (DE)

(21) Appl. No.: 16/312,299

(22) PCT Filed: Jun. 23, 2017
(86) PCT No.: PCT/DE2017/100532

§ 371 Date: Dec. 21, 2018

(30) Foreign Application Priority Data
Jun. 23, 2016 (DE) 10 2016 111 574.6

(51) Int. Cl. F01N 3/021; F01N 3/033; B01D 53/04; B01D 53/94; B01D 46/24; B01D 46/00; G01N 15/08

(52) U.S. Cl. CPC F01N 3/021; G01N 2015/084; F01N 3/0217; B01D 53/0407; B01D 53/9454; B01D 53/9481; B01D 46/2429; B01D 46/247; B01D 46/0036; G01N 15/082; B01D 2253/1124; B01D 2255/908; B01D 2046/2433; B01D 2279/30; B01D 2257/104; B01D 2259/4566; F01N 3/033

(57) ABSTRACT

An apparatus for exhaust gas purification comprises a filter function. The apparatus includes a gas-permeable substrate which forms a wall-flow filter that forms channels. The channels are sealed at least at one end and exhaust gas is flowable through the channels and gas-permeable channel walls of the channels formed from the substrate. A surface of the substrate is provided with an oxygen-storing coating. The mass of an oxygen-storing material coated on the surface of the substrate on an outflow side is higher than the mass of the oxygen-storing material coated on the surface of the substrate on an inflow side.

### CROSS-REFERENCE TO PRIOR APPLICATIONS

This application is a U.S. National Stage Application under 35 U.S.C. § 371 of International Application No. PCT/DE2017/100532 filed on Jun. 23, 2017, and claims benefit to German Patent Application No. DE 10 2016 111 574.6 filed on Jun. 23, 2016. The International Application was published in German on Dec. 28, 2017, as WO 2017/220083 A1 under PCT Article 21(2).

### FIELD

The invention relates to an apparatus for exhaust gas purification comprising a filter function, preferably a particulate filter, and a diagnostic method for this apparatus.

Filters for exhaust gas systems are known in particular as particulate filters for diesel engines. Particulate filters are also used in spark ignition engines. The components relating to exhaust gas purification have to be monitored by means of on-board diagnostics (OBD) in accordance with the legal requirements for vehicle operation, and the failure or reduced efficiency of said components has to be detected and signaled. The prior art known in particular for diesel engines includes diagnosing the filter function by means of pressure sensors and obtaining diagnostic information from the pressure difference across the filter. When filters are used in the exhaust gas system of spark ignition engines, a diagnosis of this kind is extremely difficult, since the significantly lower permissible exhaust back pressure does not allow ruptures on the filter to be reliably detected. It is therefore advantageous, in particular for systems that have low exhaust back pressure, to provide a diagnostic method that is not pressure-based.

### BACKGROUND

German patent application DE 196 06 652 A1 discloses determining the oxygen-storing capacity of a catalytic converter by means of two lambda sensors in order to determine the degree of ageing of said catalytic converter. The parameters of an oxygen filling model of the catalytic converter, which parameters have been identified from signals of the lambda sensors upstream and downstream of the catalytic converter while said catalytic converter is in operation, are considered with regard to the curve thereof, and from these parameters diagnostic information relating to the degree of ageing is formed. No diagnosis with regard to a filter function is made in this case.

DE 10 2009 000 410 A1 describes a method and a device for diagnosing an exhaust gas after-treatment apparatus comprising a catalytic converter and filter function. The functionality of the filter apparatus is deduced from the diagnostic information on the catalytic efficiency. In order to diagnose, the signal from the lambda sensors is used to determine the oxygen-storing capacity. For this purpose, the catalytic converter or the porous base substrate thereof is coated with a catalytically active material. It is assumed that damage to the channel walls leads to decreasing catalytic efficiency, and a reduced filter effect can therefore also be diagnosed. However, the method has only a low degree of discriminatory power, since the catalytic effect can decrease without there being a lowered filter function and, moreover, if there is damage in the end stopper region of the sealed channels, good catalytic efficiency is also indicated even if particles can pass unfiltered, since a catalytic reaction already occurs on the channel walls until said particles leave the filter. Owing to the thermal load in the component, a rupture in the stopper region is considered to be the most likely case, and should therefore be detected as reliably as possible.

DE 10 2011 106 933 A1 discloses a method for diagnosing a four-way catalytic converter, an oxygen-storing capacity of the catalytic apparatus being determined. The storage capacity is detected by means of the lambda sensor signal downstream of the filter and in response to a rich-to-lean/lean-to-rich transition. Damage to the filter is diagnosed from decreasing storage capacity.

DE 20 2009 018 901 U1 discloses a catalytically active particulate filter which has channels in a porous substrate in the through-flow direction of said filter, which channels are alternately sealed on the inflow or outflow side. The exhaust gas flow can therefore only reach the outflow side through the filter substrate. In order to achieve optimal utilization of the storage material, the coating containing the storage material is inhomogeneously applied to or introduced into the substrate such that the concentration of storage material is highest on the inflow side. Coatings on both the inflow side and outflow side and coatings in the pores of the substrate are described. Based on the total amount of the storage material, the greater part of the coating is in each case located on the inflow side and in the pores of the substrate. In one embodiment (FIG. 8), a channel end zone is also described which is coated with a low proportion of the storage material solely on the outer side thereof. Inhomogeneities in the coating on the surface or inhomogeneities in the pores that have an excess of weight on the inflow side are selected so as to allow an optimized oxygen-storage effect. The applied or introduced material is arranged such that it ensures storage efficiency that is as high as possible for an intact filter in the interaction thereof with the inflowing exhaust gas.

### SUMMARY

In an embodiment, the present invention provides an apparatus for exhaust gas purification comprising a filter function. The apparatus includes a gas-permeable substrate which forms a wall-flow filter that forms channels. The channels are sealed at least at one end and exhaust gas is flowable through the channels and gas-permeable channel walls of the channels formed from the substrate. A surface of the substrate is provided with an oxygen-storing coating. The mass of an oxygen-storing material coated on the surface of the substrate on an outflow side is higher than the mass of the oxygen-storing material coated on the surface of the substrate on an inflow side.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view of the apparatus for exhaust gas after-treatment comprising a filter function, which apparatus is a wall-flow filter;

FIG. 2 schematizes the curve of the lambda measurement values and the derivation thereof for an undamaged wall-flow filter;

FIG. 3 schematizes the curve of the lambda measurement values and the derivation thereof for a wall-flow filter damaged in the stopper region;

FIG. 4 schematizes the curve of the lambda measurement values and the derivation thereof for a wall-flow filter damaged in the wall region.

### DETAILED DESCRIPTION

Embodiments the present invention provide an apparatus for exhaust gas purification comprising a filter function, in particular a particulate filter having good diagnostic properties, and a method for diagnosing this apparatus that allows disturbances in the filtering capability to be detected as precisely as possible.

According to an embodiment, the apparatus for exhaust gas purification comprising a filter function consists of a gas-permeable substrate which forms a wall-flow filter that has channels for the exhaust gas flowing therethrough, which channels are sealed at least at one end. By sealing the end of the channels, the exhaust gas is forced through the gas-permeable channel walls formed from the substrate, the surface of the substrate being provided with an oxygen-storing coating. In this case the oxygen-storing coating is preferably a cerium oxide. Advantageously according to the invention, the oxygen-storing material is predominantly coated on the outflow side of the apparatus on the surface of the substrate. Coating the pores in the substrate wall can in this case also be accomplished from the outlet side, which is particularly advantageous for achieving a low exhaust back pressure. Based on the mass of the oxygen-storing material, the proportion coated on a surface of the substrate on the outflow side is higher than the proportion coated on a surface of the substrate on the inflow side. This can also include different layer thicknesses or coated regions of the surface. It is essential to the invention that the difference in storage capacity for intact and defective apparatuses is as high as possible for good diagnosability. This is achieved by means of the inhomogeneous coating. If there is a rupture in the apparatus, i.e. a leak in the stopper or wall region, at least some of the exhaust gas flow passes through the apparatus unfiltered. Oxygen-storing coatings on the inflow side therefore remain active and reduce the measurable effect of the decreasing storage capacity which is caused by a mechanical defect in the filter apparatus. A coating that is optimized with regard to diagnosability therefore has an excess of weight of the oxygen-storing material on the outflow side. This only becomes completely active if the gases pass through the substrate of the walls.

Advantageously according to an embodiment of the invention, the mass of the oxygen-storing material on the flow path of the exhaust gases through the apparatus is inhomogeneously distributed such that the amount of oxygen-storing material increases toward the outflow side. In a preferred embodiment, the amount of the oxygen-storing material coated on the surface of the substrate on the outflow side is greater than 50% based on the total mass of the oxygen-storing material of the apparatus.

In a particularly preferred embodiment, the substrate has no oxygen-storing coating at all on the inlet side, and therefore only the outlet side of the apparatus is coated with oxygen-storing material on the surface of the apparatus on the outflow side. If there is a rupture in the stopper region on the outlet side, the exhaust gas flows almost completely past the oxygen-storing coating.

In a preferred embodiment, the apparatus is a particulate filter which has a cerium oxide and/or a mixture containing a cerium oxide as the oxygen-storing material that is coated on the surface of a ceramic substrate e.g. cordierite. Advantageously according to the invention, the average pore size of the coating is smaller than the pore size of the substrate, the substrate preferably having a pore size of less than 30 μm, particularly preferably between 10 and 20 μm.

In an advantageous embodiment, the diameter of the inlet channels of the wall-flow filter in relation to the outlet channels is greater than 1. The diameter of the inlet channels is therefore larger, whereby the flow resistance of the inlet channels is smaller by comparison with the outlet channels. If the stopper region of the inlet channels ruptures, the exhaust gas is therefore preferably directed, by means of the reduced flow resistance of the inlet channels, through these inlet channels almost unimpeded, and therefore the oxygen-storing material coated on the outlet side does not become active for the exhaust gas flow. A coating that is optionally present on the inlet side is likewise permeated at a lower effectiveness, since a lower interaction with the oxygen-storing material takes place as a result of the higher flow velocity. In the case of a rupture, a clear effect that reduces the oxygen-storing capacity can therefore be measured, meaning that an improved diagnosis can be made.

Advantageously according to an embodiment of the invention, the apparatus for exhaust gas purification comprising a filter function is preferably a particulate filter which is arranged in the flow path of the exhaust gases of a spark ignition engine behind a three-way catalytic converter. The improved diagnosability is in this case particularly advantageous since an increase in the exhaust back pressure is not desired and therefore the filter function has to be designed in such a way that an increased pressure drop across the filter is small.

The method according to an embodiment of the invention for diagnosing the apparatus for exhaust gas purification comprising a filter function diagnoses a wall-flow filter which consists of a gas-permeable substrate that has channels that are alternately sealed on the inflow side and outflow side. The exhaust gas flow is in this case directed through the channel walls. The substrate that forms the channel wall in this case has an oxygen-storing coating which is coated on the surface of the substrate on the inflow side and outflow side in different proportions, the amount of the oxygen-storing material of the coating being greater on the outflow side of the wall-flow filter than on the inflow side and the oxygen-storing capacity being detected in order to diagnose the filtering capability of the apparatus and being determined using a reference value of the oxygen-storing capacity for a functional apparatus, and a diagnosis with regard to the filter function of the apparatus being obtained on the basis of the comparison.

Advantageously according to an embodiment of the invention, the extent of the damage is quantified if the storage capacity decreases, the influence of the decreasing storage capacity on the filtration efficiency being quantitatively determined on the basis of comparative data detected in tests and the apparatus being diagnosed as defective with regard to the filter function if the filtration efficiency falls below a defined threshold value.

The method according to an embodiment of the invention for diagnosing the apparatus for exhaust gas purification comprising a filter function determines diagnostic information with regard to the filtering capability from the detection of the oxygen-storing capacity of the apparatus. The apparatus is in this case a wall-flow filter according to an embodiment of the present invention, the oxygen-storing material being coated on the surface of the substrate on the outflow side at a proportion of >50% based on the total mass of the oxygen-storing material, and the oxygen-storing capacity being determined by means of lambda sensors. For this purpose, at least one lambda sensor is located in the flow path upstream of the apparatus and a further lambda sensor is located in the flow path directly downstream of the apparatus. If the oxygen content in the exhaust gas changes abruptly, the storage capacity is determined by comparing the signals of the lambda sensor upstream and downstream of the apparatus using knowledge of the exhaust gas mass flow. In this case methods are known in which the storage capacity is detected from a rich-to-lean transition by detecting the proportion of the exhaust gas mass flow which is necessary for filling the storage layer with oxygen. This can be detected at the time delay which exists between the signal of the lambda sensor arranged upstream and downstream of the apparatus. Taking the flow duration into account, the amount of exhaust gas necessary for filling the oxygen storage in lean operation is detected. After the oxygen storage has been filled, the signal of the lambda sensor arranged downstream of the apparatus follows the signal of the sensor arranged upstream of the apparatus. The oxygen-storing capacity can be estimated from the time delay, the amount of exhaust gas and the lambda value upstream of the apparatus.

A corresponding method can also be used for a lean-to-rich transition. In this case, the withdrawal of the oxygen is evaluated. The time delay of the lambda transition from lambda>1 to lower lambda values in the rich range is also considered in this case. Extracting the oxygen delays the signal transition into the rich range at the lambda sensor downstream of the apparatus, and therefore an oxygen-storing capacity can also be determined in this case from the mass of exhaust gas, lambda value and time delay. One possible embodiment is in this case determining the region enclosed between the lambda value upstream of the wall-flow filter and the lambda value downstream of the wall-flow filter. A large region is indicative of a high oxygen-storing capacity.

The invention is described in the following with reference to an exemplary embodiment.

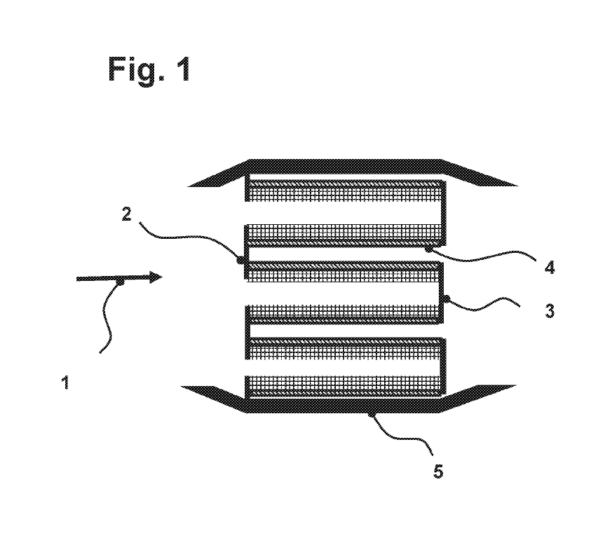

FIG. 1 is a schematic view of a wall-flow filter. An exhaust gas flow (symbolically indicated by the arrow 1) that comes from an internal combustion engine is directed via conventional exhaust gas lines of an exhaust gas system toward the wall-flow filter. This wall-flow filter consists of a housing 5 and a gas-permeable substrate arranged therein, in which substrate channels are formed that are alternately sealed on the inflow side and outflow side by means of stoppers 2, 3 such that the exhaust gas flow 1 is forced through the walls of the channels. The substrate preferably consists of ceramic material and has, in a conventional embodiment, a pore size in the range of between 10 and 20 μm. The wall-flow filter has a coating 4 on the surface of the substrate on the outflow side, which coating consists at least of an oxygen-storing material, for example cerium oxide CerO2, or which consists of a mixture of a cerium oxide with further materials that are also catalytically active. No coating is shown on the surface on the inflow side. This can also be present, but according to the invention the amount of coating on the surface of the substrate on the inflow side is less than on the outflow side.

Possible faults in the apparatuses and the evaluation thereof will be described in the following with reference to the figure. Due to the temperature distribution and the accompanying inhomogeneous thermal load on the apparatus, a leak or rupture in the channels on the stoppers 3 which seal the channels on the outflow side is the most common fault. In this case, the exhaust gas flows largely unimpeded through the channel that is now open at the end thereof when viewed in the direction of flow. In this case, the exhaust gas flow is now not filtered or only minimally filtered, and therefore the apparatus has to be accordingly diagnosed as defective with regard to the filter function thereof. Since the oxygen-storing capacity depends on the coating that is predominantly or exclusively present on the surface on the outflow side, and there is now almost no flow through the channel walls, the oxygen-storing capacity decreases sharply if there is a rupture in the stopper in the region on the outflow side. The oxygen-storing effect of the coating depends on the exhaust gas flow that reaches the outflow side through the wall. Since the portion of exhaust gas that flows through the wall is also filtered, a good correlation is made between the oxygen-storing capacity and the filtering capability.

If a leak, a rupture in the stoppers sealing the channels on the inflow side or a rupture in the wall region occurs as a result of material faults or other mechanical damage, this can also be detected. The changed flow conditions in this case also ensure a reduced oxygen-storing capacity that can be measured.

It is also possible to detect smaller cases of damage in particular in the region of the stopper 3 on the outlet side, since, as a result of the inhomogeneous distribution of the oxygen-storing coating that has an excess of weight on the outflow side, defects in the region of the stopper on the outflow side in particular have a very strong effect on the measurement result.

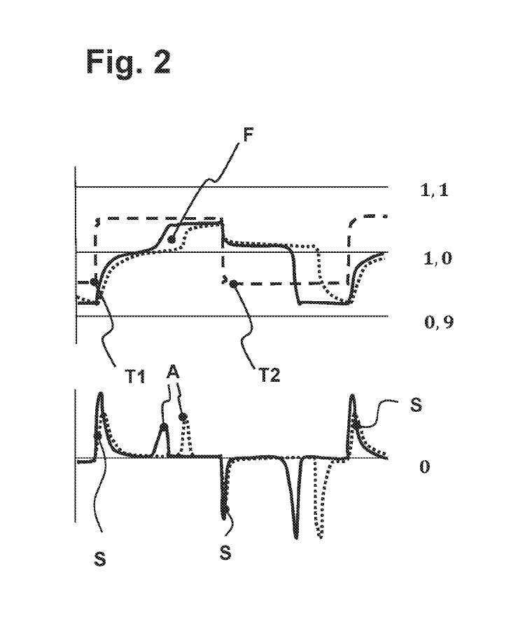

FIG. 2 shows, in two graphs, the curve of the lambda measurement values (above) and in each case the first derivation thereof (below) for an undamaged wall-flow filter which, in accordance with the invention described in FIG. 1, has a coating on the surface of the substrate on the outflow side, which coating consists of an oxygen-storing material. In the present example, the filter does not have an oxygen-storing coating on the inflow side. The measurement signal corresponds to the lambda value that is received by a wideband probe, the pump flow of the measurement cell of the wideband probe being depicted on the lambda value shown here. In the upper graph of FIG. 2, a dashed line shows the lambda target value, which, as shown here by way of example, fluctuates between a target value of lambda that is equal to 0.95 and 1.05 at an abrupt change. At the point in time T1, the lambda target value transitions from rich to lean, which transition is implemented by correspondingly actuating the fuel metering of the internal combustion engine. The lambda value upstream of the wall-flow filter (solid line) and the lambda measurement value downstream of the wall-flow filter (dotted line) follow this curve at a time delay. In the example of an undamaged wall-flow filter that is shown here, a time delay between the lambda value upstream and downstream of the wall-flow filter can be detected by means of the gas duration and the storage effects of the oxygen. At the point in time T2, the lean-to-rich transition occurs and the curve of the lambda value upstream and downstream of the wall-flow filter again follows the new target value at a time delay. The time delay between the lambda value upstream and downstream of the wall-flow filter produces a region F enclosed between these curves in the graph, which region is a measure for the oxygen-storing capacity of the coating. In the lower graph of FIG. 2, the first derivation of the lambda value upstream of the wall-flow filter (solid line) and the lambda measurement value downstream of the wall-flow filter (dotted line) is shown in each case. It can be seen that, after each point in time T1 and T2, a depictable change in the gradient is produced, caused by the change in the lambda signals. The region between the respective abrupt changes in the target value is in this case particularly interesting for the evaluation described below. The gradient curve detected here, in the case of an undamaged wall-flow filter, shows an extreme value S directly at each point in time T1 and T2, which extreme value is induced by the abrupt change in the target value. A further extreme value—peak A—occurs in the gradient curves between these extreme values S in each case. This can be seen in the gradient curve (peak) A of the lambda value upstream of the wall-flow filter and in the gradient curve of the lambda value downstream of the wall-flow filter. The sign of the extreme values of the gradients in this case depends on the direction of the target value transition.

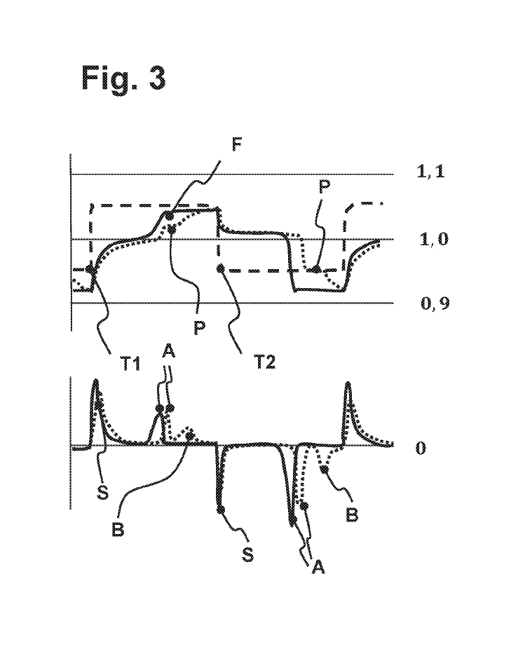

In FIG. 3, the curves of the lambda measurement values described in FIG. 2 and the first derivation thereof are shown in the same format for a damaged wall-flow filter. This wall-flow filter has a rupture in the stopper region on the outflow side. It can be seen that the shape of the curve, shown as a dotted line, of the lambda signal downstream of the wall-flow filter shows a curve that has changed by comparison with FIG. 2. In the region of the large time delay, shown for an undamaged wall-flow filter according to FIG. 2, between the lambda value upstream of the wall-flow filter (solid line) and the lambda measurement value downstream of the wall-flow filter (dotted line), the lambda value downstream of the wall-flow filter follows closer in time to the lambda value upstream of the wall-flow filter for the case shown in FIG. 3. The lambda value downstream of the wall-flow filter shows, after first following the signal, a small plateau P in the mentioned region. The changes in the lambda curve downstream of the wall-flow filter are accordingly depicted in the lower graph of the gradients. The curve of the first derivation of the lambda value downstream of the wall-flow filter has a second peak B which follows peak A and cannot be observed for an undamaged wall-flow filter. It can also be seen that the region F enclosed between the curves of the lambda value upstream and downstream of the filter is smaller than the region F which can be detected at the same position in FIG. 2. Moreover, extreme values of the gradient curve—peaks S—can be detected at each point in time T1 and T2 of the abrupt change in the lambda target value.

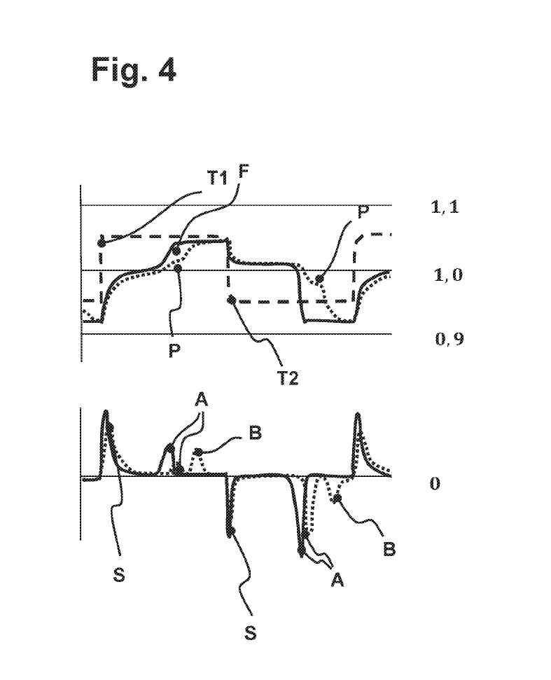

FIG. 4 schematizes the curve of the lambda measurement values and the first derivation thereof for a wall-flow filter damaged in the wall region. The shapes of the curve are shown in the same format as in FIGS. 2 and 3. It can be seen that a similar curve of the lambda values and the first derivations thereof is qualitatively produced, as previously described in FIG. 3. To varying degrees of size, both the plateau P and the peaks A and the peak B that occurs in the shape of the curve of the gradient of the lambda value downstream of the filter can be detected. The different quantitative shape of the curves is characteristic for each type of damage.

The following will describe further diagnosis concepts which complement the above-described concept of diagnosing on the basis of the oxygen-storing capacity or which can alternatively be used, and by means of which concepts damage to the filtering capability of a wall-flow filter according to the invention can be detected. As a result of the A/F control and the control stroke thereof in the target value signal, a change linked thereto in the fuel-air mixture combusted in the engine is associated in the exhaust gas mass flow, which change can be measured from the engine outlet as a cyclic influence that changes abruptly in the lambda value. The target value of the fuel mass to be injected is superimposed with the control stroke of the A/F control. This control stroke can lastly be measured from the outlet of the internal combustion engine as a cyclically changing influence on the lambda signal. This signal can be measured by means of lambda sensors, with a sensor voltage at a step-change sensor or alternatively the pump flow of a measuring cell of a wideband sensor being measured and converted into a lambda value. For the method according to the invention, at least the signals from at least one lambda sensor upstream and one downstream of the wall-flow filter are used. For the method described in the following, these values are input variables. In a first embodiment, the determination of the oxygen-storing capacity is described. In a further embodiment, a method is described in the following which uses the difference of the lambda values upstream and downstream of the wall-flow filter. After the rich-to-lean transition of the lambda target value, the point in time at which the lambda value downstream of the wall-flow filter exceeds the value 1 is awaited. The gradient of the lambda value downstream of the wall-flow filter is evaluated at a subsequent point in time. The local extreme value (peak A) that occurs first is detected and, at a time after the extreme value of the gradient curve, the difference of the lambda values upstream and downstream of the wall-flow filter is formed. The same method can also be used for the lean-to-rich transition. In this case, a different way is used to detect when the lambda value downstream of the wall-flow filter falls below the value 1. An applicable delay time that depends on the mass of gas flowing through can also be used. In this case, the point in time is determined at which, proceeding from the extreme value of the gradient of the lambda value downstream of the wall-flow filter (peak A), the applicable delay time has expired. The lambda values upstream and downstream of the wall-flow filter are used at this point in time to form the difference therefrom. If the difference exceeds a definable threshold value, it can be assumed that the wall-flow filter is damaged. For a damaged wall-flow filter, the lambda difference in the region of the plateau P is evaluated. If the described method is used on an undamaged wall-flow filter, a measurement time is produced at which the lambda value downstream of the wall-flow filter has already approached the lambda value upstream of the wall-flow filter again. The lambda difference is therefore smaller in magnitude in an undamaged wall-flow filter. It is possible to quantitatively confirm the damage on the basis of the described lambda difference. The threshold values and optionally the applicable delay time can, for example, be detected on the basis of test durations on test benches. The described method of the lambda difference can be combined with the above-described method of evaluating the oxygen-storing capacity, in order to improve the discriminatory power of the damage detection.

A further embodiment is described in the following. In this case, it is also possible to detect a damaged wall-flow filter according to the invention on the curve of the lambda signal downstream of the wall-flow filter. For this purpose, the curve itself and/or the gradient thereof is evaluated. The curve of the lambda value downstream of the wall-flow filter follows, in one region, directly after the lean-to-rich or rich-to-lean transition of the lambda target value. A first transition peak S is formed here. Following this, an almost S-shaped contour of the shape of the curve of the lambda value upstream and downstream of the wall-flow filter can be detected in an undamaged wall-flow filter. In an undamaged wall-flow filter, a peak A in the gradient of the lambda value upstream and downstream of the wall-flow filter is formed in each case. The evaluation is then carried out to find out whether a plateau-shaped curve of the lambda value downstream of the wall-flow filter can be detected after the occurrence of peak A. This can occur on the basis of the value of the lambda value downstream of the wall-flow filter that remains the same over a time period, or it is observed whether a further extreme value in the gradient curve (peak B) can be seen before the renewed target value transition of the lambda target value. The occurrence of the second extreme value (peak B) and the plateau shape following peak A are indicative of a damaged wall-flow filter.

While the method for calculating the oxygen-storing capacity can be used in principle both for wideband and step-change sensors, the described method for detecting the peak B or the plateau P in the curve of the lambda value downstream of the wall-flow filter can be used only for measuring by means of a wideband sensor upstream of the wall-flow filter and a wideband sensor downstream of the wall-flow filter. In this case, a two point sensor provides only one peak (peak A) due to the steep sensor signal, and the formation of a plateau cannot be evaluated. However, the described method of the lambda difference can also be used when using a step-change sensor upstream and downstream of the wall-flow filter. As described above, the point in time after peak A of the gradient of the lambda value downstream of the wall-flow filter is also used in this case, the difference in the sensor voltage of the lambda sensors upstream and downstream of the wall-flow filter being evaluated at said point time.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 exhaust gas flow
2 stopper on the inflow side
3 stopper on the outflow side
4 coating
5 housing
S peak/extreme value of the gradient curve of the lambda value upstream or downstream of the wall-flow filter, which directly follows the rich-to-lean or lean-to-rich transition
A peak/extreme value of the gradient curve of the lambda value upstream or downstream of the wall-flow filter (first detectable extreme value after peak S)
B peak/extreme value of the gradient curve of the lambda value downstream of the wall-flow filter (second extreme value after peak A that can optionally be detected)
F region which is enclosed in the graph between the curves of the temporal curve of the lambda values upstream and downstream of the wall-flow filter
T1 point in time of the rich-to-lean transition of the target value of the lambda sensor signal
T2 point in time of the lean-to-rich transition of the target value of the lambda sensor signal
P plateau in the curve of the lambda value downstream of the wall-flow filter

1. An apparatus for exhaust gas purification comprising a filter function, the apparatus comprising:
a gas-permeable substrate which forms a wall-flow filter that forms channels, the channels being sealed at least at one end, exhaust gas being flowable through the channels and gas-permeable channel walls of the channels formed from the substrate, a surface of the substrate being provided with an oxygen-storing coating,
wherein the mass of an oxygen-storing material coated on the surface of the substrate on an outflow side is higher than the mass of the oxygen-storing material coated on the surface of the substrate on an inflow side.

2. The apparatus for exhaust gas purification according to claim 1, wherein the mass of the oxygen-storing material on a flow path of the exhaust gas through the apparatus is inhomogeneously distributed, the amount of the oxygen-storing material increasing toward the outflow side.

3. The apparatus for exhaust gas purification according to claim 1, wherein a proportion of the oxygen-storing material on the surface of the substrate on the outflow side, based on the total mass of the oxygen-storing material, is greater than 50%.

4. The apparatus for exhaust gas purification according to claim 1, wherein the oxygen-storing material is coated only on the outflow side of the apparatus.

5. The apparatus for exhaust gas purification according to claim 1, wherein the apparatus is a particulate filter which has a cerium oxide as the oxygen-storing material, and wherein the substrate is a ceramic substrate.

6. The apparatus for exhaust gas purification according to claim 1, wherein a pore size of the oxygen-storing material coated on the surface of the substrate on the outflow side is smaller than a pore size of the substrate.

7. The apparatus for exhaust gas purification according to claim 1, wherein a diameter of inlet channels is greater than a diameter of the outlet channels.

8. The apparatus for exhaust gas purification according to claim 1, wherein the apparatus is arranged in a flow path of the exhaust gas of a spark ignition engine being a three-way catalytic converter.

9. A method for diagnosing an apparatus for exhaust gas purification comprising a filter function, wherein the apparatus comprises a gas-permeable substrate which forms a wall-flow filter that forms channels that are alternately sealed on an inflow side and an outflow side such that exhaust gas flows through channel walls of the channels and the substrate that forms the channel walls has an oxygen-storing coating which is coated on a surface of the substrate in a different proportion on the outflow side compared to on the inflow side, wherein an amount of oxygen-storing material of the coating is greater on the outflow side of the wall-flow filter than on the inflow side,
detecting an oxygen-storing capacity in order to diagnose a filtering capability of the apparatus;
comparing the detected oxygen-storing capacity with a reference value of the oxygen-storing capacity for a functional apparatus; and
obtaining diagnostic information with regard to the filter function of the apparatus based on the comparison.

10. The method according to claim 9, wherein an extent of damage is quantified in a case that the oxygen-storage capacity decreases, an influence of the decreasing oxygen-storage capacity on filtration efficiency being quantitatively determined and the apparatus being diagnosed as defective with regard to the filter function in a case that the filtration efficiency falls below a defined threshold value.

11. A method for diagnosing an apparatus for exhaust gas purification comprising a filter function, the method comprising:
providing the apparatus comprising a gas-permeable substrate which forms a wall-flow filter that forms channels, the channels being sealed at least at one end, exhaust gas flowing through the channels and gas-permeable channel walls formed from the substrate, a surface of the substrate being provided with an oxygen-storing coating, the mass of an oxygen-storing material coated on the surface of the substrate on an outflow side being higher than the mass of the oxygen-storing material coated on the surface of the substrate on an inflow side, the oxygen-storing material, based on the total mass of the oxygen-storing material, coating the outflow side at a proportion of >50% based on the total mass;
deriving diagnostic information with regard to the filtering capability of the apparatus from determining an oxygen-storing capacity of the apparatus, wherein the determination of the oxygen-storing capacity of the oxygen-storing material is made using lambda sensors, wherein at least one lambda sensor is located in a flow path of the exhaust gas upstream of the apparatus and a further lambda sensor is located in the flow path of the exhaust gas directly downstream of the apparatus, and wherein, in a case that the oxygen content in the exhaust gas changes abruptly, the oxygen-storing capacity is determined by comparing signals of the at least one lambda sensor upstream and the further sensor downstream of the apparatus.

12. A method for diagnosing an apparatus for exhaust gas purification comprising a filter function, wherein the apparatus comprises a gas-permeable substrate that forms a wall-flow filter that forms channels that are alternately sealed on an inflow side and an outflow side such that exhaust gas flows through channel walls of the channels and the substrate that forms the channel walls has an oxygen-storing coating which is coated on a surface of the substrate in a different proportion on the outflow side than on the inflow side, wherein an amount of oxygen-storing material of the coating is greater on the outflow side of the wall-flow filter than on the inflow side,
using a curve of a measured lambda value upstream and downstream of the wall-flow filter, in a region between abrupt changes of a lambda target value, to diagnose the filtering capability, wherein an evaluation time for the lambda signal upstream and downstream of the wall-flow filter is detected from evaluation of the curve of the gradient of the lambda value downstream of the wall-flow filter; and
detecting, at the evaluation time, a difference of the lambda values or alternatively of respective sensor voltages, wherein the difference of the lambda values or of the sensor voltages is compared with a threshold value at this point in time and the wall-flow filter is diagnosed as defective in a case that the threshold value is exceeded.

13. A method for diagnosing an apparatus for exhaust gas purification comprising a filter function, wherein the apparatus comprises a gas-permeable substrate that forms a wall-flow filter that forms channels that are alternately sealed on an inflow side and an outflow side such that the exhaust gas flows through channel walls of the channels and the substrate that forms the channel walls has an oxygen-storing coating which is coated on a surface of the substrate in a different proportion on the outflow side than on the inflow side, wherein an amount of oxygen-storing material of the coating is greater on the outflow side of the wall-flow filter than on the inflow side, the method comprising:
using a curve of a measured lambda value upstream and downstream of the wall-flow filter, in a region between the abrupt changes of a lambda target value, to diagnose the filtering capability, wherein an evaluation time for the lambda signal downstream of the wall-flow filter is detected from evaluation of the curve of the gradient of the lambda value downstream of the wall-flow filter by observing the curve of the lambda value downstream of the wall-flow filter at a point in time directly following an extreme value of the gradient curve (peak A); and
diagnosing the wall-flow filter as defective in a case that a plateau (P) that directly follows the extreme value of the gradient curve (peak A) is detected in the curve of the lambda value downstream of the wall-flow filter or in a case that a second extreme value is detected in the gradient curve of the lambda value downstream of the wall-flow filter (peak B), the second extreme value occurring before a renewed abrupt change in the lambda target value.
